(19) United States
(12) Patent Application Publication
(10) Pub. No.: US 2012/0238670 A1
(43) Pub. Date: Sep. 20, 2012

(54) Water-Soluble, Hydrophobically Associating Nanocomposites (As Rheology Modifiers For Applications In Construction Chemistry)

(76) Inventors: Yulia Fogel, Munster (DE); Peter Gaeberlein, Magdeburg (DE); Stefan Friedrich, Garching (DE); Andrea Orleans, Trostberg (DE)

(21) Appl. No.: 13/504,150

(22) PCT Filed: Oct. 28, 2010
(86) PCT No.: PCT/EP2010/066370

§ 371 Date: Jun. 4, 2012

(30) Foreign Application Priority Data
Nov. 3, 2009 (EP) 09174907.7

(51) Int. Cl. C08F 230/08; C04B 24/26; C08K 3/00; C09J 183/02; B82Y 30/00

(52) U.S. Cl. 524/3; 526/279; 977/773

(57) ABSTRACT

Hydrophobically associating nanocomposites which contain a silica, a hydrophobically modified monomer and a hydrophilic monomer. The silica constituent comprises an aqueous colloidal solution of amorphous silicon dioxide (SiO₂), from 0.1 to 10% by weight of the hydrophobically modified monomer and from 10% by weight to 99.9% by weight of the hydrophilic monomer. The preparation of nanocomposites is effected by a free radical polymerization as gel polymerization in the aqueous phase. These nanocomposites have a substantially improved action as water retention agents and rheology modifiers in aqueous construction material systems and have improved properties compared with currently used products.

The present invention relates to nanocomposites, a process for the preparation of nanocomposites and the use of nanocomposites for aqueous construction material systems.

### BACKGROUND OF THE INVENTION

Nanocomposites are sufficiently well known and, owing to their specific monomer composition, are employed in a very wide range of fields of use.

In the construction chemistry area, nanocomposites are frequently also used as water retention agents, also referred to as fluid loss additives. A specific field of use in this context is the cementing of wells in the development of underground mineral oil and natural gas deposits.

In non-flowable construction material systems, water-soluble nonionic derivatives of polysaccharides, in particular cellulose and starch derivatives, are often used as rheology modifiers and water retention agents in order to retard or to prevent the undesired evaporation of the water which is required for hydration and workability or the flowing away of said water into the ground. In renders, adhesive mortars, filling compounds and joint fillers, but also in air-placed concretes for tunnel construction and in underwater concretes, water retention is controlled by means of such additives. Consequently, such additives also have a decisive influence on the consistency (plasticity), smoothability, segregation, tack, adhesion (to the ground and to the tool), sag-resistance and slip-resistance and adhesive strength and compressive strength or shrinkage.

U.S. Pat. No. 6,187,887 B and US 2004/024154 describe high molecular weight polymers which contain sulpho groups and have good water retention properties. Common to these polymers is that these polyelectrolytes have a net anionic charge.

However, another important property of the additives in tile adhesives and renders is the thickening in the presence of increased salt concentrations.

The polymers according to U.S. Pat. No. 6,187,887 B show a drastic decrease in thickening under such conditions, whereas additives according to US 2004/024154 are relatively stable in the presence of increased salt concentrations.

In the case of high-performance tile adhesives, it is desirable, for example, to establish particularly short curing times in order to ensure the possibility of walking at an early stage (about 5 hours) on the laid tiles even at low temperatures (about 5° C.). This is achieved by extremely high doses of salts which act as accelerators, for example calcium formate. In the case of the use of such high salt loads (divalent cations are particularly critical), the polymers according to US 2004/024154 also lose a major part of their efficiency.

To this extent, there is a certain necessity for formulating such high-performance tile adhesives with water-soluble, nonionic derivatives of polysaccharides, in particular cellulose ethers, as water retention agents. However, this implies a number of disadvantages for the user, which is due to the fact that cellulose ethers have low thermal flocculation points, which in the end means that the water retentivity becomes drastically weaker at temperatures above 30° C. Moreover, cellulose ethers, particularly at relatively high doses, tend to have high tacks, which in turn must be toned down by the addition of further formulation components, which has additional disadvantages.

In addition to the anionic polymers described above, cationic copolymers, e.g. DE102006050761 A1; DE102007012786 A1, can also be used for the purpose of thickening or of water retention.

It was therefore the object of the present invention to provide water-soluble, hydrophobically associating nanocomposites as water retention agents and rheology modifiers for aqueous construction material systems, which do not have said disadvantages of the prior art, such as the slipping of the tiles, but, for example, improve the wetting of the back of the tile with the tile adhesive, the tack and the workability of the construction material mixture and the air pore stability of the tile adhesive mortar.

This object was achieved by providing nanocomposites consisting of at least one silica of the structural unit (a), which has been reacted with an unsaturated silane, at least one hydrophobically modified monomer as structural unit (b), at least one hydrophilic monomer as structural unit (c) and a crosslinking monomer comprising at least two ethylenically unsaturated groups as structural unit (d).

It has now surprisingly been found that these nanocomposites have a substantially improved action as water retention agents and exhibit improved properties compared with currently used products. This is evident in particular in improved wetting of the back of the tile with tile mortar, reduced slipping of the tiles from the wall, optimized tack of the tile mortar and air pore stability in combination with shorter mixing time.

### DETAILED DESCRIPTION OF THE INVENTION

Regarding the silica constituent of the monomer (a), it has been found to be advantageous in the context of the present invention if this silica constituent originates from an aqueous colloidal solution of amorphous silicon dioxide (SiO₂) and preferably from a nanosilica. So-called nanosilica and microsilica have been found to be particularly suitable for the subsequent reaction with an unsaturated silane. Nanosilicas are aqueous, colloidal solutions which contain exclusively silicon dioxide. The mean particle size of this silicon dioxide is in the range between 5 and 500 nm, ranges between 15 and 100 nm and in particular between 30 and 70 nm being preferable. Microsilica consists of particles having an order of magnitude of 0.5 to about 100 μm. This includes, for example, pyrogenic silicas, precipitated silicas, furnace dusts and fly ashes.

The silane compound which was reacted with said silica to give the monomer (a) should, according to the invention be an ethylenically unsaturated alkoxysilane. The number of carbon atoms in these alkoxysilanes should be between 5 and 15. Compounds of the series consisting of 3-methacryloyloxypropyltrialkoxysilane, 3-methacryloyloxypropyldialkoxyalkylsilane, methacryloyloxymethyltrialkoxysilane, (methacryloyloxymethyl)dialkoxyalkylsilane, vinyldialkoxyalkylsilane or vinyltrialkoxysilane have been found to be particularly suitable. Silanes which initially have no double bond but can be converted into a silane containing a double bond by reaction with a suitable ethylenically unsaturated compound are also suitable. For example, the reaction product of aminopropyltrimethoxysilane and maleic anhydride is suitable here. It is also possible to adopt a stepwise procedure here, i.e. first the silica is allowed to react with the aminosilane, reaction with maleic anhydride is then effected in the next step and finally polymerization is effected at the double bond.

Suitable hydrophobically modified monomers as structural unit (b) comprise in particular members of the general formula H₂C═C(R¹)—COO—(—CH₂—CH(R²)—O—)_{q}—R³ or H₂C═C(R¹)—O—(—CH₂—CH(R²)—O—)_{q}—R³, in which q represents a number from 10 to 150, preferably 12 to 100, particularly preferably 15 to 80, very particularly preferably 20 to 30 and in particular 25, R¹═H, methyl. Radicals R², independently of one another, represent H, methyl or ethyl, preferably H or methyl, with the proviso that at least 50 mol % of the radicals R² are H. Preferably, at least 75 mol % of the radicals R² are H, particularly preferably at least 90 mol % of the radicals R² are H and very particularly preferably R² denotes exclusively H. Radical R³ is an aliphatic and/or aromatic, straight-chain or branched hydrocarbon radical having at least 6 carbon atoms, in particular 6 to 40 carbon atoms, preferably 8 to 30 carbon atoms. Examples include n-alkyl groups, such as n-octyl, n-decyl or n-dodecyl groups, phenyl groups and in particular substituted phenyl groups. The substituents of the phenyl groups may be alkyl groups, for example C₁- to C₆-alkyl groups, preferably styryl groups. A tristyrylphenyl group is particularly preferred. Said hydrophobically associating monomers are known in principle to the person skilled in the art.

The proportion of the hydrophobically associating monomers (b), based on the nanocomposite, depends on the respective intended use of the nanocomposites according to the invention and is in general 0.1 to 20% by weight, based on the total amount of all monomers in the nanocomposite. The proportion is preferably 0.5 to 20% by weight.

Over and above the monomers (a) and (b), the nanocomposites according to the invention comprise at least one monomer (c) from the group consisting of monoethylenically unsaturated, hydrophilic monomers. Of course, any desired mixtures of the monomers (a), (b) and (c) and in particular a plurality of different hydrophilic monomers (c) may also be present.

The nanocomposites comprise water-soluble and preferably hydrophobically associating nanocomposites.

In a preferred embodiment of the invention, the water-soluble, hydrophobically associating nanocomposites comprise a monoethylenically unsaturated, hydrophobically modified monomer (b), preferably in amounts of 0.1 to 10% by weight, and a monoethylenically unsaturated, hydrophilic monomer (c), preferably in amounts of 10% by weight to 99.9% by weight.

In addition to an ethylenic group, the hydrophilic monomers (c) comprise one or more hydrophilic groups. Owing to their hydrophilicity, they impart sufficient water solubility to the nanocomposites according to the invention. The hydrophilic groups are in particular functional groups which comprise O and/or N atoms. They may moreover comprise heteroatoms, in particular S and/or P atoms. The hydrophilic monomers (c) may be miscible in any desired ratio with water, without this necessarily having to be the case. As a rule, the solubility in water at room temperature should be at least 100 g/l, preferably at least 200 g/l and particularly preferably at least 500 g/l.

Examples of suitable functional groups comprise carbonyl groups >C═O, ether groups —O—, in particular polyethylene oxide groups —(CH₂—CH₂—O—)ₙ—, in which n preferably represents a number from 1 to 200, hydroxyl groups —OH, ester groups —C(O)O—, primary, secondary or tertiary amino groups, ammonium groups, amide groups —C(O)—NH—, carboxamide groups —C(O)—NH₂ or acidic groups, such as carboxyl groups —COOH, sulpho groups —SO₃H, phosphonic acid groups —PO₃H₂ or phosphoric acid groups —OP(OH)₃.

Examples of preferred functional groups comprise the hydroxyl group —OH, carboxyl group —COOH, sulpho group —SO₃H, carboxamide group —C(O)—NH₂, amide group —C(O)—NH— and polyethylene oxide groups —(CH₂—CH₂—O—)ₙ—H, in which n preferably represents a number from 1 to 200.

The functional groups may be bonded directly to the ethylenic group or one or more functional, hydrophilic groups may be linked via one or more linking hydrocarbon groups to the ethylenic group.

The hydrophilic monomers (c) are preferably monomers of the general formula H₂C═C(R⁴)R⁵, in which R⁴ represents H or methyl and R⁵ represents a hydrophilic group or a radical comprising one or more hydrophilic groups.

The monomers (c) which are miscible in any desired ratio with water are particularly preferred. For carrying out the invention, however, it is sufficient for the hydrophobically associating nanocomposites according to the invention to have the water solubility mentioned. The groups R⁵ are groups which comprise heteroatoms in an amount such that the defined water solubility is reached.

Examples of the structural unit (c1) comprise monomers comprising hydroxyl and/or ether groups, such as, for example, hydroxyethyl(meth)acrylate, hydroxypropyl(meth)acrylate, allylalcohol, hydroxyvinyl ethyl ether, hydroxyvinyl propyl ether, hydroxyvinyl butyl ether or compounds of the formula H₂C═C(R¹)—COO—(—CH₂—CH(R⁶)—O—)_{b}—R⁷ or H₂C═C(R¹)—O—(—CH₂—CH(R⁶)—O—)_{b}—R⁷, in which R¹ is as defined above and b represents a number from 2 to 200, preferably 2 to 100. The radicals R⁶, independently of one another, are H, methyl or ethyl, preferably H or methyl, with the proviso that at least 50 mol % of the radicals R⁶ are H. Preferably, at least 75 mol % of the radicals R⁶ are H, particularly preferably at least 90 mol % are H and the radicals R⁶ are very particularly preferably exclusively H. The radical R⁷ is H, methyl or ethyl, preferably H or methyl. The individual alkylene oxide units may be arranged randomly or blockwise. In a block copolymer, the transition between the blocks may be abrupt or gradual.

Acrylamide and methacrylamide and derivatives thereof, such as, for example, N-methyl(meth)acrylamide, N,N′-dimethyl(meth)acrylamide and N-methylolacrylamide, N-vinylderivates, such as N-vinylformamide, N-vinylacetamide, N-vinylpyrrolidone or N-vinylcaprolactam, and vinyl esters, such as vinyl formate or vinyl acetate, may furthermore be mentioned as representatives of a neutral monomer (c2). After polymerization, N-vinyl derivatives can be hydrolyzed to vinylamine units, and vinyl esters to vinyl alcohol units.

Examples of suitable anionic monomers (c3) comprise monomers comprising —COOH groups, such as acrylic acid or methacrylic acid, crotonic acid, itaconic acid, maleic acid or fumaric acid, monomers comprising sulpho groups, such as vinylsulphonic acid, allylsulphonic acid, 2-acrylamido-2-methylpropanesulphonic acid (AMPS), 2-methacrylamido-2-methylpropanesulphonic acid, 2-acrylamidobutanesulphonic acid, 3-acrylamido-3-methylbutanesulphonic acid or 2-acrylamido-2,4,4-trimethylpentanesulphonic acid, or monomers comprising phosphonic acid groups, such as vinylphosphonic acid, allylphosphonic acid, N-(meth)acrylamidoalkylphosphonic acids or (meth)acryloyloxyalkylphosphonic acids.

In a preferred embodiment of the invention, the nanocomposites according to the invention comprise at least one anionic monomer (c3) comprising acidic groups. These are preferably monomers which comprise at least one group selected from the group consisting of —COOH, —SO₃H or —PO₃H₂, particularly preferably monomers comprising —COOH groups and/or —SO₃H groups.

Suitable hydrophilic monomers (c4) are monomers having ammonium groups, in particular N-(ω-aminoalkyl)(meth)acrylamides or ω-aminoalkyl(meth)acrylic esters.

In particular, the variant (c4) may be compounds of the general formulae H₂C═C(R⁴)—CO—NR¹⁰—R⁸—NR⁹₃⁺ X⁻ and/or H₂C═C(R⁷)—COO—R⁸—NR⁹₃⁺ X⁻, in which R⁴ has the abovementioned meaning, i.e. represents H or methyl, R⁸ represents a preferably linear C₁- to C₄-alkylene group and R¹⁰ represents H or a C₁- to C₄-alkyl group, preferably H or methyl. The radicals R⁸, independently of one another, are C₁- to C₄-alkyl, preferably methyl, or a group of the general formula —R¹¹—SO₃H, in which R¹¹ represents a preferably linear C₁- to C₄-alkylene group or a phenyl group, with the proviso that as a rule not more than one of the substituents R⁵ is a substituent having sulpho groups. Particularly preferably, the three substituents R⁹ are methyl groups, i.e. the monomer has a group —N(CH₃)₃⁺—X⁻ in the above formula represents a monovalent anion, for example Cl⁻. Examples of suitable monomers (c4) comprise salts of 3-trimethylammonium propyl acrylamides and 2-trimethylammoniummethyl(meth)acrylates, for example the corresponding chlorides, such as 3-trimethylammonium propyl acrylamide chloride (DIMAPAQUAT) and 2-trimethylammonium ethyl methacrylate chloride (MADAMEQUAT).

The abovementioned hydrophilic monomers can of course be used not only in the acid or base form described but also in the form of corresponding salts.

Preferably, at least one of the monomers (c) is a monomer selected from the group consisting of (meth)acrylic acid, vinylsulphonic acid, allylsulphonic acid or 2-acrylamido-2-methylpropanesulphonic acid (AMPS), particularly preferably acrylic acid.

The amount of the monomers (c) in the nanocomposite according to the invention is 25 to 99.9% by weight, based on the total amount of all monomers in the nanocomposite, preferably 25 to 99.5% by weight. The exact amount depends on the type and on the desired use of the hydrophobically associating nanocomposites.

The nanocomposites according to the invention may also comprise monomers (d) which have at least two, preferably two, ethylenically unsaturated groups. As a result, it is possible to achieve a certain crosslinking provided that this has no undesired adverse effects in the intended application. Too high a degree of crosslinking should, however, be avoided in any case; in particular, the required water solubility of the nanocomposites must not be impaired. Examples of such monomers (d) comprise 1,6-hexanediol di(meth)acrylate, diethylene glycol di(meth)acrylate, triethylene glycol di(meth)acrylate or oligoethylene glycol di(meth)acrylates, methylenebisacrylamide, triallylamine or triallylaminemethammonium chloride, pentaerythrityl triallyl ether.

Crosslinking monomers (d) are used only in small amounts. As a rule, the amount of the monomers (d) should not exceed 1% by weight, based on the amount of all monomers used. Preferably, not more than 0.5% by weight and particularly preferably not more than 0.1% by weight should be used. Very particularly preferably, no monomers (d) at all are used.

In a further preferred embodiment of the invention, the nanocomposites according to the invention may be used as an additive for aqueous construction material systems which contain hydraulic binder systems. Examples of such hydraulic binder systems comprise cement, lime, gypsum or anhydrite.

Examples of such construction material systems comprise non-flowable construction material systems, such as tile adhesives, renders or joint fillers, and flowable construction material systems, such as self-levelling flow filling compounds, sealing and repair mortar, self-levelling screeds, flowable concrete, self-compacting concrete, underwater concrete or underwater mortar.

The preferred amounts in which the nanocomposites according to the invention are used are between 0.001 and 5% by weight, depending on the method of use and based on the dry weight of the construction material system.

The nanocomposites according to the invention can also be used in combination with nonionic polysaccharide derivatives, such as methylcellulose (MC), hydroxyethylcellulose (HEC), hydroxypropylcellulose (HPC), methylhydroxyethylcellulose (MHEC), methylhydroxypropylcellulose (MHPC) and welan gum or diutan gum.

For dry mortar applications (e.g. tile adhesive, sealing mortar, render, plaster, self-levelling screeds), the preferably hydrophobically associating nanocomposites according to the invention are used in powder form. It is advisable to choose the size distribution of the particles by adaptation of the grinding parameters so that the mean particle diameter is less than 100 μm and the proportion of particles having a particle diameter greater than 200 μm is less than 2% by weight. Those powders whose mean particle diameter is less than 60 μm and in which the proportion of particles having a particle diameter greater than 120 μm is less than 2% by weight are preferred. Those powders whose mean particle diameter is less than 50 μm and in which the proportion of particles having a particle diameter greater than 100 μm is less than 2% by weight are particularly preferred.

In concrete, the nanocomposites according to the invention are preferably used in the form of aqueous solutions. The coarser granules of the nanocomposites according to the invention, having a mean particle diameter between 300 μm and 800 μm, the proportion of particles having a particle diameter of less than 100 μm being less than 2% by weight, are particularly suitable for the preparation of the solutions. The same applies if the nanocomposites according to the invention are dissolved in other concrete admixtures or formulations comprising concrete admixtures (for example in a plasticizer).

For the abovementioned use as an additive for aqueous construction material systems containing hydraulic binders, the hydrophobically associating nanocomposite (A1) described below can preferably be used.

Accordingly, in a preferred embodiment, the invention relates to a preferred, hydrophobically associating nanocomposite (A1). The preferred nanocomposite (A1) is suitable in particular as an additive for non-flowable construction material systems, such as tile adhesives, renders or joint fillers.

In a preferred embodiment of the invention, the nanocomposites according to the invention are represented by a nanocomposite (A1) which comprises at least four different hydrophilic monomers (c), and preferably at least
neutral hydrophilic monomer (c1) of the formula H₂C═C(R¹)—COO—(—CH₂—CH(R⁶)—O—)_{b}—R⁷, and
neutral hydrophilic monomer (c2) differing from (c1), and preferably comprising neutral monomers, such as acrylamide or methacrylamide, and derivatives thereof, and N-vinyl derivatives, such as N-vinylpyrrolidone, N-vinylformamide, N-vinylacetamide or N-vinylcaprolactam,
anionic monomer (c3) which comprises at least one acidic group selected from the group consisting of carboxyl group —COOH, sulpho group —SO₃H or phosphonic acid group —PO₃H₂, and
cationic monomer (c4) which comprises at least one ammonium group of the general formula H₂C═C(R⁴)—CO—NR¹⁰—R⁸—NR⁹₃⁺] X⁻,

the amount of the monomers (b) being 0.1 to 10% by weight and that of all monomers (c) together being 70 to 99.5% by weight, based on the amount of all monomers in the nanocomposite.

In the case of the hydrophobically associating nanocomposite (A1), the monomers (a) are used in an amount of 0.1 to 12% by weight, preferably 0.4 to 5% by weight. Preferably, the nanocomposite (A1) contains only monomers (a), (b), (c) and (d) and particularly preferably only monomers (a), (b) and (c).

In a preferred embodiment of the monomer (b), monomers of the general formula H₂C═C(R¹)—COO—(—CH₂—CH(R²)—O—)_{q}—R³ and/or H₂C═C(R¹)—O—(—CH₂—CH(R²)—O—)_{q}—R³ can be used in the nanocomposite (A1). The meaning of the radicals and indices and preferred ranges have already been described. In the case of such a mixture, the proportion of said specific monomers should as a rule be at least 25% by weight, based on the amount of all monomers (b), preferably 40 to 90% by weight and, for example, 40 to 60% by weight.

The nanocomposite (A1) comprises, as monomers (c), at least one neutral monomer (c1) of the formula H₂C═(R¹)—COO—(—CH₂—CH(R⁶)—O—)_{b}—R⁷, a neutral monomer (c2) and at least one anionic monomer (c3) and/or at least one cationic monomer (c4), preferably at least one neutral monomer (c2) and at least one cationic monomer (c4).

Examples of suitable monomers (c1), (c2), (c3) and (c4) have already been mentioned.

The neutral monomers (c1) in the nanocomposite (A1) are monomers comprising hydroxyl and/or ether groups, such as, for example, hydroxyethyl(meth)acrylate, hydroxypropyl(meth)acrylate, allylalcohol, hydroxyvinyl ethyl ether, hydroxyvinyl propyl ether, hydroxyvinyl butyl ether or compounds of the formula H₂C═C(R¹)—COO—(—CH₂—CH(R⁶)—O—)_{b}—R⁷ or H₂C═C(R¹)—O—(—CH₂—CH(R⁶)—O‘)_{b}—R⁷, in which R¹ is as defined above and b represents a number from 2 to 200, preferably 2 to 100. The radicals R⁶, independently of one another, are H, methyl or ethyl, preferably H or methyl, with the proviso that at least 50 mol % of the radicals R⁶ are H. Preferably, at least 75 mol % of the radicals R⁶ are H, particularly preferably at least 90 mol % and very particularly preferably are exclusively H. The radical R⁷ is H, methyl or ethyl, preferably H or methyl. The individual alkylene oxide units may be arranged randomly or blockwise. In the case of a block copolymer, the transition between the blocks may be abrupt or gradual.

In a preferred embodiment of the invention, the nanocomposites according to the invention comprise, in the case of the neutral monomers (c2) differing from (c1) in the nanocomposite (A1), an acrylamide or methacrylamide and derivatives thereof, such as, for example N-methyl(meth)acrylamide, N,N′-dimethyl(meth)acrylamide, N-methylolacrylamide, and N-vinyl derivatives, such as N-vinylformamide, N-vinylacetamide, N-vinylpyrrolidone or N-vinylcaprolactam. Preferred monomers (c2) in the nanocomposite (A1) are acrylamide, methacrylamide and N-vinylpyrrolidone.

The anionic monomers (c3) in the nanocomposite (A1) are monomers comprising acid groups, preferably monomers which contain at least one of the groups from the group consisting of carboxyl group —COOH, sulpho group —SO₃H or phosphonic acid group —PO₃H₂.

The anionic monomers (c3) are preferably monomers comprising sulpho groups —SO₃H. Examples of preferred monomers comprise vinylsulphonic acid, allylsulphonic acid, 2-acrylamido-2-methylpropanesulphonic acid (AMPS), 2-acrylamidobutanesulphonic acid, 3-acrylamido-3-methylbutanesulphonic acid and 2-acrylamido-2,4,4-trimethylpentanesulphonic acid; 2-acrylamido-2-methylpropanesulphonic acid (AMPS) is preferred.

The cationic monomers (c4) in the nanocomposites (A1) are preferably the abovementioned monomers of the formulae H₂C═C(R⁴)—CO—NR¹⁰—R⁸—NR⁹₃⁺ X⁻ and/or H₂C═C(R⁷)—COO—R⁸—NR⁹₃⁺ X⁻, in which the radicals and the ranges are species preferred in each case are in each case as defined above. 3-Trimethylammonium propyl acrylamide chloride (DIMAPAQUAT) is particularly preferred.

In the nanocomposites (A1), the amount of anionic monomers (c3) and of cationic monomers (c4) is as a rule 25 to 80% by weight, based on the sum of all monomers, preferably 40 to 75% by weight, particularly preferably 45 to 70% by weight, and that of the neutral monomers (c2) is 15 to 60% by weight, preferably 20 to 50% by weight, and that of the neutral monomers (c1) is 1 to 30% by weight, preferably 5 to 20% by weight, with the proviso that the sum of the monomers (c1) and (c2) and (c3) and (c4) together is 70 to 99.9% by weight. The monomers (a) and (b) are used in the amounts mentioned.

In a preferred embodiment of the invention, the nanocomposites according to the invention comprise a cationic monomer with salts of 3-trimethylammonium propyl(meth)acrylamides and 2-trimethylammoniumethyl(meth)acrylates.

Preferred nanocomposites (A1) comprise either an anionic monomer (c3) or a cationic monomer (c4) in the amounts already mentioned. If a mixture of (c3) and (c4) is used, the weight ratio (c3):(c4) can be freely chosen.

In a further preferred embodiment of the invention, the nanocomposites according to the invention moreover comprise at least one cationic monomer (c4) having ammonium groups.

In a preferred embodiment, the nanocomposites contain a nanocomposite (A2) which contains at least two different hydrophilic monomers (c) selected from the group consisting of
neutral hydrophilic monomer (c2) differing from (c1), and
anionic monomer (c3) which comprises at least one acidic group selected from the group consisting of carboxyl group —COOH, sulpho group —SO₃H or phosphonic acid group —PO₃H₂,
the amount of the monomers (b) then being 0.1 to 10% by weight and that of all monomers (c) together being 70 to 99.9% by weight, based on the amount of all monomers in the nanocomposite.

For the abovementioned preferred use as an additive for aqueous construction material systems containing hydraulic binders, the hydrophobically associating nanocomposite (A2) described below may furthermore preferably be used.

Accordingly, in a third preferred embodiment, the invention relates to a preferred, hydrophobically associating nanocomposite (A2). The preferred nanocomposite (A2) is suitable in particular as an additive for flowable construction material systems, in particular for concrete, self-levelling screeds, self-levelling filling compounds and sealing mortar.

The hydrophobically associating nanocomposite (A2) contains the monomers (a) in an amount of 0.1 to 12% by weight, preferably 0.4 to 5% by weight. Preferably, the nanocomposite (A2) contains only monomers (a), (b), (c) and (d) and particularly preferably only monomers (a), (b) and (c).

In a preferred embodiment of monomer (b), the nanocomposite (A2) can, however, also contain the monomers (b) as a mixture with other hydrophobically associating monomers, preferably those of the general formula H₂C═C(R¹)—COO—(—CH₂—CH(R²)—O—)_{q}—R³ and/or H₂C═C(R¹)—O—(—CH₂—CH(R²)—O—)_{q}—R³. The meaning of the radicals and indices and preferred ranges have already been described at the outset. In such a mixture, the proportion of the monomers should as a rule be at least 25% by weight, based on the amount of all monomers (b), preferably 40 to 90% by weight and, for example, 40 to 60% by weight. Preferred monomers (b) have already been mentioned above.

The nanocomposite (A2) comprises, as monomers (c), at least one neutral monomer (c2) and at least one anionic monomer (c3). Examples of suitable monomers (c2) and (c3) have already been mentioned.

The neutral monomers (c2) are acrylamide or methacrylamide and derivatives thereof, such as, for example, N-methyl(meth)acrylamide, N,N′-dimethyl(meth)acrylamide, N-methylolacrylamide, and N-vinyl derivatives, such as N-vinylformamide, N-vinylacetamide, N-vinylpyrrolidone or N-vinylcaprolactam. Preferred monomers (c2) in the nanocomposite (A2) are acrylamide, methacrylamide and N-vinylpyrrolidone.

The anionic monomers (c3) are monomers comprising acid groups, preferably monomers which comprise at least one group selected from carboxyl group —COOH, sulpho group —SO₃H or phosphonic acid group —PO₃H₂.

In the nanocomposites (A2), the monomers (c3) are preferably monomers comprising sulpho groups —SO₃H. Examples of preferred monomers comprise vinylsulphonic acid, allylsulphonic acid, 2-acrylamido-2-methylpropanesulphonic acid (AMPS), 2-acrylamidobutanesulphonic acid, 3-acrylamido-3-methylbutanesulphonic acid and 2-acrylamido-2,4,4-trimethylpentanesulphonic acid; 2-acrylamido-2-methylpropanesulphonic acid (AMPS) is preferred.

In the preferred nanocomposites (A2), the amount of anionic monomers (c3) is as a rule 25 to 94.9% by weight, based on the sum of all monomers, preferably 50 to 90% by weight, particularly preferably 60 to 90% by weight, and that of the neutral monomers (c2) is 5 to 50% by weight, preferably 5 to 30% by weight, with the proviso that the sum of the monomers (c2) and (c3) together is 70 to 99.9% by weight. The monomers (c) are used in the amounts mentioned at the outset.

Finally, the invention comprises a process for the preparation of nanocomposites by free radical polymerization in the aqueous phase, by free radical polymerization in inverse emulsion or by free radical polymerization in inverse suspension.

The nanocomposites according to the invention can be prepared by free radical polymerization of the monomers (a), (b), (c) or additionally (d) by known methods, for example by mass, solution, gel, emulsion or suspension polymerization, preferably in the aqueous phase.

In a preferred embodiment of the present invention, the process for the preparation of nanocomposites is effected by free radical polymerization as a gel polymerization in the aqueous phase.

In a further preferred embodiment, the preparation is carried out by means of gel polymerization in the aqueous phase, provided that all monomers used have sufficient water solubility. For the gel polymerization, first a mixture of the monomers, initiators and other auxiliaries with water or an aqueous solvent mixture is provided. Suitable aqueous solvent mixtures comprise water and water-miscible organic solvents, the proportion of water being as a rule at least 50% by weight, preferably at least 80% by weight and particularly preferably at least 90% by weight. In particular, water-miscible alcohols, such as methanol, ethanol or propanol, may be mentioned here as organic solvents. Acidic monomers can be completely or partly neutralized before the polymerization. A pH of 4 to about 9 is preferred. The concentration of all components, with the exception of the solvents, is usually 25 to 60% by weight, preferably 30 to 50% by weight.

The mixture is then photochemically and/or thermally polymerized, preferably at −5° C. to 50° C. If thermal polymerization is effected, polymerization initiators which initiate even at comparatively low temperature, such as, for example, redox initiators, are preferably used. The thermal polymerization can be carried out even at room temperature or by heating the mixture, preferably to temperatures of not more than 50° C. The photochemical polymerization is usually carried out at temperatures from −5° C. to 10° C. Photochemical and thermal polymerization can particularly advantageously be combined with one another by adding both initiators for thermal polymerization and initiators for photochemical polymerization to the mixture. Here, the polymerization is first initiated photochemically at low temperatures, preferably at −5° C. to 10° C. As a result of the liberated heat of reaction, the mixture heats up and the thermal polymerization is additionally initiated thereby. By means of this combination, it is possible to achieve a conversion of more than 99%.

The gel polymerization takes place as a rule without stirring. It may be effected batchwise by irradiating and/or heating the mixture in a suitable vessel with a layer thickness of 2 to 20 cm. As a result of the polymerization, a solid gel forms. The polymerization can also be effected continuously. For this purpose, a polymerization apparatus which has a conveyor belt for receiving the mixture to be polymerized is used. The conveyor belt is equipped with apparatuses for heating or for exposure to UV radiation. Accordingly, the mixture is poured on at one end of the belt by means of a suitable apparatus, the mixture polymerizes in the course of being conveyed in the belt direction and the solid gel can be removed at the other end of the belt.

The gel is comminuted and dried after the polymerization. The drying should preferably be effected at temperatures below 100° C. In order to avoid caking, a suitable anticaking agent can be used for this step. The hydrophobically associating nanocomposites are obtained as powder.

Further details for carrying out a gel polymerization are disclosed, for example, in DE 10 2004 032 304 A1, paragraphs [0037] to [0041].

The nanocomposites according to the invention preferably have a number average molecular weight Mₙ of 50 000 to 20 000 000 g/mol.

The following examples are intended to illustrate the invention in more detail:

Preparation of Hydrophobically Associating Nanocomposites

### EXAMPLE 1

### E 1

Hydrophobically associating nanocomposite of the type (A1) comprising acrylamide (24.9% by weight), an anionic monomer acrylamido-2-methylpropanesulphonic acid sodium salt (68% by weight), polyethylene glycol-(3000) vinyloxybutyl ether (5% by weight) and hydrophobically associating monomer (b) (2% by weight).

1 g of Levasil® 300/30% (silicasol from H.C. Starck), 10 g of distilled H₂O and 0.3 g (0.1% by weight, 0.1 mol %) of methacryloyloxypropyltrimethoxysilane (Dynasylan MEMO from Degussa AG) were stirred overnight at room temperature. The following components were then mixed with one another in succession in a 2 litre three-necked flask having a stirrer and thermometer:

527.70 g of acrylamido-2-methylpropanesulphonic acid sodium salt (58% strength by weight solution in water; 48.1 mol %),

1.6 g of silicone antifoam,

2.4 g of pentasodium diethylenetriaminepentaacetate (complexing agent),

175.0 g of acrylamide (50% strength by weight solution in water; 51.4 mol %),

11.70 g of monomer (b) (60% strength by weight solution in water; 0.2 mol %),

29.20 g of polyethylene glycol-(3000) vinyloxybutyl ether (VOB, 60% strength by weight solution in water; 0.2 mol %)

3.2 g of formic acid (10% strength by weight solution in water) were added as a chain-transfer agent. The solution was adjusted to pH 7 with 20% strength sodium hydroxide solution, rendered inert by flushing with nitrogen for 10 minutes and cooled to about 5° C. The solution was transferred to a plastic container, and 250 ppm of 2,2′-azobis(2-amidinopropane)dihydrochloride 1% strength solution, 20 ppm tert-butyl hydroperoxide 0.1% strength solution and 30 ppm of bisulphite 1% strength solution were then added in succession. The polymerization was initiated by exposure to UV light (two Philips tubes; Cleo Performance 40 W). After 2 h, the hard gel was removed from the plastic container and cut with scissors into approx. 5 cm×5 cm×5 cm gel cubes. Before the gel cubes were comminuted by means of a conventional mincer, they were coated with a commercially available anticaking agent Sitren 595 (from Goldschmidt). The anticaking agent is a polydimethylsiloxane emulsion, which was diluted 1:20 with water. The gel granules obtained were distributed uniformly on a drying grid and dried in a circulation drying oven at 90-120° C. in vacuo to constant weight.

### EXAMPLE 2

### E 2

Hydrophobically associating nanocomposite of the type (A1) comprising acrylamide (24.6% by weight), acrylamido-2-methylpropanesulphonic acid sodium salt (68% by weight), polyethylene glycol-(3000) vinyloxybutyl ether (5% by weight) and hydrophobically associating monomer (b) (2% by weight).

As in example 1, the experiment was carried out with the following components:

4 g of Levasil® 300/30% (silicasol from H.C. Starck), 10 g of distilled H₂O and 1.4 g (0.4% by weight, 0.2 mol %) of methacryloyloxypropyltrimethoxysilane (Dynasylan MEMO from Degussa AG) were stirred overnight at room temperature. The following components were then mixed with one another in succession in a 2 litre three-necked flask having a stirrer and thermometer:

527.70 g of acrylamido-2-methylpropanesulphonic acid sodium salt (58% strength by weight solution in water; 48.3 mol %),

1.6 g of silicone antifoam,

2.4 g of pentasodium diethylenetriaminepentaacetate (complexing agent),

172.80 g of acrylamide (50% strength by weight solution in water; 51.0 mol %),

11.70 g of monomer (b) (60% strength by weight solution in water; 0.2 mol %),

29.20 g of polyethylene glycol-(3000) vinyloxybutyl ether (60% strength by weight solution in water; 0.2 mol %)

### EXAMPLE 3

### E 3

Hydrophobically associating nanocomposite of the type (A1) comprising acrylamide (29.9% by weight), acrylamido-2-methylpropanesulphonic acid sodium salt (40% by weight), N-vinylpyrrolidone (28% by weight) and hydrophobically associating monomer (b) (2% by weight).

As in example 1, the experiment was carried out with the following components, but without a chain-transfer agent:

1 g of Levasil® 300/30% (silicasol from H.C. Starck), 10 g of distilled H₂O and 0.3 g (0.1% by weight, 0.1 mol %) of methacryloyloxypropyltrimethoxysilane (Dynasylan MEMO from Degussa AG) were stirred overnight at room temperature. The following components were then mixed with one another in succession in a 2 litre three-necked flask having a stirrer and thermometer:

278.50 g of acrylamido-2-methylpropanesulphonic acid sodium salt (58% strength by weight solution in water; 22.2 mol %),

1.6 g of silicone antifoam,

2.4 g of pentasodium diethylenetriaminepentaacetate (complexing agent),

188.60 g of acrylamide (50% strength by weight solution in water; 48.4 mol %),

10.50 g of monomer (b) (60% strength by weight solution in water; 0.1 mol %),

89.0 g of N-vinylpyrrolidone (29.2 mol %)

### EXAMPLE 4

### E 4

Hydrophobically associating nanocomposite of the type (A1) comprising acrylamide (29.6% by weight), acrylamido-2-methylpropanesulphonic acid sodium salt (40% by weight), N-vinylpyrrolidone (28% by weight) and hydrophobically associating monomer (b) (2% by weight).

As in example 3, the experiment was carried out with the following components:

4 g of Levasil® 300/30% (silicasol from H.C. Starck), 10 g of distilled H₂O and 1.4 g (0.4% by weight, 0.2 mol %) of methacryloyloxypropyltrimethoxysilane (Dynasylan MEMO from Degussa AG) were stirred overnight at room temperature. The following components were then mixed with one another in succession in a 2 litre three-necked flask having a stirrer and thermometer:

278.50 g of acrylamido-2-methylpropanesulphonic acid sodium salt (58% strength by weight solution in water; 22.3 mol %),

1.6 g of silicone antifoam,

2.4 g of pentasodium diethylenetriaminepentaacetate (complexing agent),

188.60 g of acrylamide (50% strength by weight solution in water; 48.1 mol %),

10.50 g of monomer (b) (60% strength by weight solution in water; 0.1 mol %),

89.0 g of N-vinylpyrrolidone (29.3 mol %)

### EXAMPLE 5

### E 5

Hydrophobically associating nanocomposite of the type (A1) comprising acrylamide (32.6% by weight), polyethylene glycol-(3000) vinyloxybutyl ether (5% by weight), a cationic monomer 3-(acrylamino)propyltrimethylammonium chloride (57% by weight), acrylic acid (2% by weight) and hydrophobically associating monomer (b) (3% by weight).

The experiment was carried out as in example 1 with the following components, but 0.6 g of formic acid (10% strength by weight solution in water) was used as a chain-transfer agent:

4 g of Levasil® 300/30% (silicasol from H.C. Starck), 10 g of distilled H₂O and 1.4 g (0.4% by weight, 0.2 mol %) of methacryloyloxypropyltrimethoxysilane (Dynasylan MEMO from Degussa AG) were stirred overnight at room temperature. The following components were then mixed with one another in succession in a 2 litre three-necked flask having a stirrer and thermometer:

170 g of distilled water,

1.6 g of silicone antifoam,

2.4 g of pentasodium diethylenetriaminepentaacetate (complexing agent),

5.6 g of acrylic acid (99.5% strength; 3.6 mol %),

266.0 g of 3-(acrylamino)propyltrimethylammonium chloride (60% strength by weight solution in water; 35.8 mol %),

183.0 g of acrylamide (50% strength by weight solution in water; 59.9 mol %),

14.0 g of monomer (b) (60% strength by weight solution in water; 0.2 mol %)

23.40 g of polyethylene glycol-(3000) vinyloxybutyl ether (VOB, 60% strength by weight solution in water; 0.2 mol %)

### EXAMPLE 6

### E 6

Hydrophobically associating nanocomposite of the type (A1) comprising acrylamide (27.9% by weight), N-vinylpyrrolidone (28% by weight), 3-(acrylamino)propyltrimethylammonium chloride (40% by weight), acrylic acid (2% by weight) and hydrophobically associating monomer (b) (2% by weight).

The experiment was carried out as in example 1 with the following components, but 0.6 g of formic acid (10% strength by weight solution in water) was used as a chain-transfer agent:

1 g of Levasil® 300/30% (silicasol from H.C. Starck), 10 g of distilled H₂O and 0.3 g (0.1% by weight, 0.1 mol %) of methacryloyloxypropyltrimethoxysilane (Dynasylan MEMO from Degussa AG) were stirred overnight at room temperature. The following components were then mixed with one another in succession in a 2 litre three-necked flask having a stirrer and thermometer:

170 g of distilled water,

1.6 g of silicone antifoam,

2.4 g of pentasodium diethylenetriaminepentaacetate (complexing agent),

6.1 g of acrylic acid (99.5% strength; 3.2 mol %),

202.60 g of 3-(acrylamino)propyltrimethylammonium chloride (60% strength by weight solution in water; 22.2 mol %),

175.30 g of acrylamide (50% strength by weight solution in water; 45.2 mol %),

10.20 g of monomer (b) (60% strength by weight solution in water; 0.1 mol %)

86.0 g of N-vinylpyrrolidone (28% by weight; 29.2 mol %)

### EXAMPLE 7

### E 7

Hydrophobically associating nanocomposite of the type (A2) comprising dimethylacrylamide (19.2% by weight), acrylamido-2-methylpropanesulphonic acid sodium salt (79.9% by weight) and hydrophobically associating monomer (b) (0.8% by weight).

The experiment was carried out as in example 1 with the following components, but 4 g of formic acid (10% strength by weight solution in water) were used as a chain-transfer agent:

1 g of Levasil® 300/30% (silica sol from H.C. Starck), 10 g of distilled H₂O and 0.3 g (0.1% by weight, 0.1 mol %) of methacryloxypropyltrimethoxysilane (Dynasylan MEMO from Degussa AG) were stirred overnight at room temperature. Thereafter, the following components were mixed with one another in succession in a 2 litre three-necked flask having a stirrer and thermometer:

612.70 g of acrylamido-2-methylpropanesulphonic acid sodium salt (58% strength by weight solution in water; 66.5 mol %),

1.6 g of silicone antifoam,

67.22 g of dimethylacrylamide (33.4 mol %),

4.60 g of monomer (b) (60% strength by weight solution in water; 0.1 mol %)

### EXAMPLE 8

### E 8

Hydrophobically associating nanocomposite of the type (A2) comprising dimethylacrylamide (19.2% by weight), acrylamido-2-methylpropanesulphonic acid sodium salt (79.6% by weight) and hydrophobically associating monomer (b) (0.8% by weight).

The experiment was carried out as in example 1 with the following components, but 6 g of formic acid (10% strength by weight solution in water) were used as a chain-transfer agent:

4 g of Levasil® 300/30% (silica sol from H.C. Starck), 10 g of distilled H₂O and 1.4 g (0.4% by weight, 0.3 mol %) of methacryloyloxypropyltrimethoxysilane (Dynasylan MEMO from Degussa AG) were stirred overnight at room temperature. Thereafter, the following components were mixed with one another in succession in a 2 litre three-necked flask having a stirrer and thermometer:

610.61 g of acrylamido-2-methylpropanesulphonic acid sodium salt (58% strength by weight solution in water; 66.2 mol %),

1.6 g of silicone antifoam,

67.21 g of dimethylacrylamide (33.4 mol %),

4.60 g of monomer (b) (60% strength by weight solution in water; 0.1 mol %)

### COMPARATIVE EXAMPLE 1

### C 1

Hydrophobically associating copolymer with acrylamide and 3-(acrylamino)propyltrimethylammonium chloride without monomer (a) according to the invention.

The experiment was carried out as in example 1 with the following components:

170 g of distilled water,

1.6 g of silicone antifoam,

2.4 g of pentasodium diethylenetriaminepentaacetate (complexing agent),

5.4 g of acrylic acid (99.5% strength; 2.9 mol %),

148 g of 3-(acrylamino)propyltrimethylammonium chloride (60% strength by weight solution in water; 18.3 mol %),

259.7 g of acrylamide (50% strength by weight solution in water; 78.6 mol %),

20.0 g of polyethylene glycol-(3000) vinyloxybutyl ether (VOB, 60% strength by weight solution in water; 0.2 mol %),

8.0 g of monomer (b) (60% strength by weight solution in water; 0.1 mol %)

### COMPARATIVE EXAMPLE 2

### C 2

Hydrophobically associating copolymer with acrylamide and acrylamido-2-methylpropanesulphonic acid sodium salt without monomer (a) according to the invention.

The experiment was carried out as in example 1 with the following components:

170 g of distilled water,

1.6 g of silicone antifoam,

2.4 g of pentasodium diethylenetriaminepentaacetate (complexing agent),

528 g of acrylamido-2-methylpropanesulphonic acid sodium salt (58% strength by weight solution in water; 48.1 mol %),

175 g of acrylamide (50% strength by weight solution in water; 51.5 mol %),

29.2 g of polyethylene glycol-(3000) vinyloxybutyl ether (VOB, 60% strength by weight solution in water; 0.2 mol %),

11.9 g of monomer (b) (60% strength by weight solution in water, 0.2 mol %).

### COMPARATIVE EXAMPLE 3

### C 3

The following components were mixed with one another in a 2 litre three-necked flask having a stirrer and thermometer:

1.6 g of silicone antifoam,

578.00 g of acrylamido-2-methylpropanesulphonic acid sodium salt (58% strength by weight solution in water; 62.2 mol %)

104.80 g of acrylamide (50% strength by weight solution in water; 36.4 mol %),

43.50 g of polyethylene glycol-(1100) vinyloxybutyl ether (VOB, 60% strength by weight solution in water; 1.4 mol %)

300 ppm of formic acid (10% strength by weight solution in water) were added as a chain-transfer agent. The solution was adjusted to pH 7 with 20% strength sodium hydroxide solution. After flushing with nitrogen (10 min), the solution was rendered inert and cooled to about 5° C. The solution was transferred to a plastic container and 150 ppm of 2,2′-azobis(2-amidinopropane) dihydrochloride 1% strength solution, 6 ppm of tert-butyl hydroperoxide 0.1% strength solution, 6 ppm of Rongalit 1% strength solution and 3 ppm of FeSO₄*7H₂O 1% strength solution were then added in succession. The working-up was effected as described above.

Testing of Performance Characteristics

Test in a Tile Adhesive Mortar:

The properties of the nanocomposites of type (A1) were tested in a test mix of a tile adhesive mortar. The composition of the test mix is described in DE 10 2006 050 761 A1, page 11, table 1. Said test mix is a dry mix which was formulated ready for use and with which in each case 0.5% by weight of the hydrophobically associating nanocomposite to be tested was mixed in solid form. A certain amount of water was then added to the dry mix and the latter was stirred thoroughly by means of a suitable mixing apparatus (drill with G3 mixer). The required mixing time was measured. The tile adhesive was initially left to mature for 5 min.

The following tests were carried out with the stirred tile adhesive mortar:
Slump The determination of the slump was carried out according to DIN 18555, part 2, and was effected immediately after the maturing time and, if required, at later times.
Water retention The water retention was determined 15 min after stirring according to DIN 18555, part 7.
Wetting The tile adhesive formulation was applied to a concrete slab according to EN 1323 and a tile (5 cm×5 cm) was placed on top after 10 min. Thereafter, the tile was loaded for 30 s with a 2 kg weight. After a further 60 min, the tile was removed and the percentage of the back of the tile to which tile mortar still adhered was determined.
Slip The slip was determined 3 min after stirring according to DIN EN 1308. The slip distance in mm is stated.
Tack The determination of the tack or ease of movement of the test mix was effected by a qualified person skilled in the art.
Air pore stability The determination of the air pore stability was effected visually by a qualified person skilled in the art.

The nanocomposites used in each case and the results obtained are listed in table 2.

Test in a Self-Compacting Concrete

The properties of the nanocomposites of type (A2) were tested in a test mix of a self-compacting concrete. The composition of the test mix is described in DE 10 2004 032 304 A1, page 23, table 11.

Preparation of the Mortar Mixes:

The self-compacting concretes were mixed in the laboratory using a 50 litre positive mixer. The efficiency of the mixer was 45%. During the mixing process, first aggregates and flour-fine substances were homogenized for 10 seconds in a mixer before the mixing water, the plasticizer and the nanocomposite (as aqueous solution or as powder) were then added. The mixing time was 4 minutes. Thereafter, the fresh concrete test (slump flow) was carried out and rated. The variation in consistency was observed over 120 minutes.

Determination of the Slump Flow

For determining the slump flow, a so-called Abrams cone (internal diameter at top 100 mm, internal diameter at bottom 200 mm, height 300 mm) was used (slump flow=diameter of the concrete cake in cm, measured over two axes perpendicular to one another and averaged). The determination of the slump flow was carried out four times per mix, i.e. at the times t=0, 30, 60 and 90 minutes after the end of mixing, the mix being thoroughly stirred again with a concrete mixer for 60 seconds before the respective slump flow determination.

The bleeding and the sedimentation were assessed visually by a person skilled in the art. The values were determined directly after stirring and after 20 minutes.

The nanocomposites used in each case and the results obtained are listed in tables 1 and 2.

The nanocomposites (A1, E1-E6; table 1) show an improved effect as a water retention agent and improved properties compared with currently used products (C1 and C2). Furthermore, in particular the wetting of the back of the tile with tile mortar, the slip of the tile from the wall, the tack of the tile mortar, the air pore stability and the ease of movement of the test mix could be improved with a simultaneous short mixing time. The nanocomposites (A2, E7-E8, table 2) show an improved effect as a rheology modifier in a self-compacting concrete and avoid sedimentation and bleeding of the concrete.

TABLE 1
Results of the examples and comparative examples

| | Component | | | | | | | | |
|---|---|---|---|---|---|---|---|---|---|
| | | | | | | | | | Cellulose |
| | | | | | | | | | ether MHPC |
| | E 1 | E 2 | E 3 | E 4 | E 5 | E 6 | C1 | C2 | 30000 |
| Mixing time [s] | 15 | 15 | 15 | 15 | 25 | 23 | 16 | 18 | 6 |
| Slump | 17.7 | 18.4 | 18 | 17.9 | 18.3 | 17.3 | 17.2 | 18.2 | 16.2 |
| Water retention [%] | 98.5 | 98.5 | 98.4 | 98.4 | 98.5 | 98 | 97.8 | 98 | 98.6 |
| Wetting [%] | 89 | 91 | 91 | 90 | 89 | 89.1 | 85.9 | 90 | 70 |
| Slip [mm] | 2 | 2 | 2 | 2 | 2 | 2 | 2 | 3 | 8 |
| Tack | high | high | high | high | high | high | high | high | very high |
| Air pore stability | very | very | very | very | very | very | good | good | good |
| | good | good | good | good | good | good | | | |

TABLE 2
Results of the examples and comparative examples

| | | | Without | |
|---|---|---|---|---|
| Component | Example 7 | Example 8 | polymer | C3 |
| Dose; % | 0.015 | 0.015 | 0 | 0.02 |
| Slump flow | 73 | 72 | 75 | 74 |
| (immediately) | | | | |
| Bleeding | none | none | pronounced | none |
| (immediately) | | | | |
| Sedimentation | none | none | pronounced | none |
| (immediately) | | | | |
| Slump flow (after 20 min) | 73 | 72 | 74 | 72 |
| Bleeding (after 20 min) | none | none | pronounced | none |
| Sedimentation (after | none | none | pronounced | none |
| 20 min) | | | | |

1. Nanocomposites consisting of:
(a) at least one silica of the structural unit (a), which has been reacted with an unsaturated silane,
(b) at least one hydrophobically modified monomer of the structural unit (b),
(c) at least one hydrophilic monomer of the structural unit (c).

2. Nanocomposites according to claim 1, wherein the silica constituent (a) originates from an aqueous colloidal solution of amorphous silicon dioxide (SiO₂) and optionally from a nanosilica.

3. Nanocomposites according to claim 1, wherein the nanocomposites are water-soluble, hydrophobically associating nanocomposites.

4. Nanocomposites according to claim 3, comprising
(a) 0.1 to 10% by weight of a monoethylenically unsaturated. hydrophobically modified monomer (b) and
(b) 10% by weight to 99.9% by weight of a monoethylenically unsaturated, hydrophilic monomer (c).

5. Nanocomposites according to claim 1, wherein the structural unit (b) is represented by the following general formulae (II) or (III):
H₂C═C(R¹)—COO—(—CH₂—CH(R²)—O—)_{q}—R³ (II)
H₂C═C(R¹)—O—(—CH₂—CH(R²)—O—)_{q}—R³ (III)
in which
q: represents a number from 10 to 150,
R¹: represents H, or methyl,
R²: independently of one another represents H, methyl or ethyl, with the proviso that at least 50 mol % of the radicals R² are H,
R³: represents an aliphatic and/or aromatic, straight-chain or branched hydrocarbon radical having at least 6 carbon atoms, optionally 6 to 40 carbon atoms.

6. Nanocomposites according to any of claim 1, wherein at least one of the monomers (c) represents at least one monomer comprising acidic groups.

7. Nanocomposites according to claim 6, wherein the acidic groups are at least selected from one of the groups —COOH, —SO₃H or —PO₃H₂.

8. Nanocomposites according to any of claim 1, represented by a nanocomposite (A1) which contains at least four different hydrophilic monomers (c) selected from the group consisting of
neutral hydrophilic monomer (c1) of the formula H₂C═C(R¹)—COO—(—CH₂—CH(R⁶)—O—)_{b}—R⁷,
neutral hydrophilic monomer (c2) differing from (c1), and optionally comprising neutral monomers, acrylamide, methacrylamide, or derivatives thereof, N-vinyl derivatives, N-vinylpyrrolidone, N-vinylformamide, N-vinylacetamide or N-vinylcaprolactam,
anionic monomer (c3) which comprises at least one acidic group selected from the group consisting of carboxyl group —COOH, sulpho group —SO₃H and phosphonic acid group —PO₃H₂, and
cationic monomer (c4) which comprises at least one ammonium group of the general formula H₂C═C(R⁴)—CO—NR¹⁰—R⁸—NR⁹₃⁺ X⁻,
the amount of the monomers (b) then being 0.1 to 10% by weight and the amount of all monomers (c) together being 70 to 99.5% by weight, based on the amount of all monomers in the nanocomposite, wherein
R⁴: represents H or methyl,
R⁶: independently of one another, are H, methyl or ethyl, with the proviso that at least 50 mol % of the radicals R⁶ are H,
R⁷: represents H, methyl or ethyl,
R⁸: independently of one another, are C₁- to C₄-alkyl, or a group of the general formula —R¹¹—SO₃H, in which R¹¹ represents a linear C₁- to C₄-alkylene group or a phenyl group,
R⁹: are methyl groups,
R¹⁰: represents H or a C₁- to C₄-alkyl group, and
X⁻: represents a monovalent anion.

9. Nanocomposites according to claim 8, wherein the neutral monomer (c2) comprises a monomer selected from the group consisting of (meth)acrylamide, N-methyl(meth)acrylamide, N,N′-dimethyl(meth)acrylamide, N-methylol(meth)acrylamide and N-vinyl-2-pyrrolidone and the monomer (c3) comprises at least one monomer selected from the group consisting of (meth)acrylic acid, vinylsulphonic acid, allylsulphonic acid, 2-acrylamido-2-methylpropanesulphonic acid (AMPS), 2-methacrylamido-2-methylpropanesulphonic acid, 2-acrylamidobutanesulphonic acid, 3-acrylamido-3-methylbutanesulphonic acid, 2-acrylamido-2,4,4-trimethylpentanesulphonic acid and vinylphosphonic acid.

10. Nanocomposites according to claim 8, wherein the cationic monomer (c4) comprises salts of 3-trimethylammonium propyl(meth)acrylamides and/or 2-trimethylammoniumethyl(meth)acrylates.

11. Nanocomposites according to claim 1, represented by a nanocomposite (A2) which contains at least two different hydrophilic monomers (c) selected from the group consisting of
neutral hydrophilic monomer (c2) differing from neutral hydrophilic monomer (c1), and
anionic monomer (c3) which comprises at least one acidic group selected from the group consisting of carboxyl group —COOH, sulpho group —SO₃H and phosphonic acid group —PO₃H₂,
the amount of the monomers (b) then being 0.1 to 10% by weight and the amount of all monomers (c) together being 70 to 99.9% by weight, based on the amount of all monomers in the nanocomposite.

12. Process for the preparation of nanocomposites according to any claim 1 by free radical polymerization of the component a) with the monomers b) and c) and optionally d) in the aqueous phase, by free radical polymerization in inverse emulsion or by free radical polymerization of an inverse suspension.

13. Process according to claim 12, wherein the free radical polymerization is effected as a gel polymerization in the aqueous phase.

14. Process of using the nanocomposites according to claim 1 as an admixture for aqueous construction material systems which contain hydraulic binder systems, optionally cement, lime, gypsum or anhydrite, comprising adding the nanocomposites to the aqueous construction material systems containing hydraulic binder systems.

15. The process according to claim 14, wherein the construction material system is a dry mortar composition, a tile adhesive or plaster.

16. Nanocomposites according to claim 5, in which the radicals R² are exclusively H.
